(19) United States
(12) Patent Application Publication
(10) Pub. No.: US 2016/0257814 A1
(43) Pub. Date: Sep. 8, 2016

(54) LIGNOCELLULOSIC MATERIALS CONTAINING DEFIBRILLATED CELLULOSE

(71) Applicant: BASF SE, Ludwigshafen (DE)

(72) Inventors: Matthias SCHADE, Limburgerhof (DE); Stephan WEINKÖTZ, Neustadt (DE); Jens AßMANN, Neustadt (DE)

(21) Appl. No.: 15/027,933

(22) PCT Filed: Sep. 29, 2014
(86) PCT No.: PCT/EP2014/070785

§ 371 Date: Apr. 7, 2016

(30) Foreign Application Priority Data
Oct. 10, 2013 (EP) 13188006.4

(51) Int. Cl. C08L 97/02; B29C 43/52; B29C 43/00; B29C 43/20

(52) U.S. Cl. CPC C08L 97/02; B29C 43/203; B29C 43/52; B29C 43/003; B29K 2001/00

(57) ABSTRACT

The present invention provides novel and improved lignocellulose materials comprising
A) 30 to 98.99 wt % of one or more lignocellulosics,
B) 0.01 to 50 wt % of microfibrillated cellulose.
C) 1 to 50 wt % of a binder selected from the group consisting of amino resin, phenol-formaldehyde resin, organic isocyanate having two or more isocyanate groups, or mixtures thereof, optionally with a curing agent,
D) 0 to 25 wt % of expanded plastics particles having a bulk density in the range from 10 to 150 kg/m³, and
E) 0 to 68 wt % of additives.

The present invention relates to lignocellulose materials comprising one or more lignocellulosics, microfibrillated cellulose and binder, optionally expanded or expandable plastics particles and optionally additives and also to methods of producing same.

DE19947856A1 discloses wood fiber board, in particular MDF board, where cellulose fiber recovered from wastepaper was substituted for some wood fiber. Up to 90% admixtures of wastepaper cellulose fiber to wood fiber were tested therein. However, the mechanical properties of the board are not reported.

Holz als Roh-und Werkstoff 1970, 28, 3, pages 101 to 104, discloses chipboard comprising admixed wastepaper strips. Wastepaper was comminuted in a file shredder, mixed 1:1 with wood chips, resinated and compressed into chipboard. There are problems with mixing the paper with the wood chips and the mechanical properties leave something to be desired.

It is an object of the present invention to remedy the aforementioned disadvantages, in particular to produce lignocellulose materials having improved mechanical properties.

We have found that this object is achieved by novel and improved lignocellulose materials comprising
A) 30 to 98.99 wt % of one or more lignocellulosics,
B) 0.01 to 50 wt % of microfibrillated cellulose.
C) 1 to 50 wt % of a binder selected from the group consisting of amino resin, phenol-formaldehyde resin, organic isocyanate having two or more isocyanate groups, or mixtures thereof, optionally with a curing agent,
D) 0 to 25 wt % of expanded plastics particles having a bulk density in the range from 10 to 150 kg/m³, and
E) 0 to 68 wt % of additives.

We have further found a novel and improved method of producing lignocellulose materials, which comprises
A) 30 to 98.99 wt % of one or more lignocellulosics,
B) 0.01 to 50 wt % of microfibrillated cellulose.
C) 1 to 50 wt % of a binder selected from the group consisting of amino resin, phenol-formaldehyde resin, organic isocyanate having two or more isocyanate groups, or mixtures thereof, optionally with a curing agent,
D) 0 to 25 wt % of expanded plastics particles having a bulk density in the range from 10 to 150 kg/m³, and
E) 0 to 68 wt % of additives
   being mixed and subsequently compressed at elevated temperature and at elevated pressure.

Components A), B), C) and optionally D) and E) sum to 100%,

The term “lignocellulose material” denotes single- or multilayered lignocellulose materials, i.e., lignocellulose materials having from one to five layers, preferably from one to three layers and more preferably one or three layers. Lignocellulose materials in this context comprehend optionally veneered chip-base, OSB or fiber-base materials, in particular wood fiber base materials such as LDF, MDF and HDF materials, preferably chip- or fiber-base materials, more preferably chip-base materials. Materials include panels, tiles, moldings, semi-fabricates or composites, preferably panels, tiles, moldings or composites, more preferably panels.

Component A

Lignocellulosics comprise lignocellulose. The lignocellulose content may be varied within wide limits and is generally from 20 to 100 wt %, preferably from 50 to 100 wt %, more preferably from 85 to 100 wt % and in particular equal to 100 wt % of lignocellulose. The term “lignocellulose” is known to a person skilled in the art.

One or more lignocellulosics are suitably, for example, straw, woody plants, wood or mixtures thereof. The two or more lignocellulosics are generally from 2 to 10, preferably from 2 to 5, more preferably from 2 to 4 and in particular 2 or 3 different lignocellulosics.

Wood suitably comprises wood fibers or wood particles such as wood laths, wood strips, wood chips, wood dust or mixtures thereof, preferably wood chips, wood fibers, wood dust or mixtures thereof, more preferably wood chips, wood fibers or mixtures thereof. Woody plants are suitably, for example, flax, hemp or mixtures thereof.

Starting materials for wood particles or wood fibers are generally forestry thinnings, industrial wood residuals and used lumber and also woody plants and plant parts.

Wood particles or wood fibers may derive from any desired species of wood such as softwood or hardwood from deciduous or coniferous trees, inter alia from residual industrial wood or plantation wood, preferably eucalyptus, spruce, beech, pine, larch, lime, poplar, ash, chestnut and fir wood or mixtures thereof, more preferably eucalyptus, spruce and beech wood or mixtures thereof, in particular eucalyptus and spruce wood or mixtures thereof.

Lignocellulosics in the invention are generally comminuted and used as particles or fibers.

Suitable particles include sawdust chips, woodchips, planing chips, wood particles, optionally comminuted cereal straw, shives, cotton stems or mixtures thereof, preferably sawdust chips, planing chips, woodchips, wood particles, shives or mixtures thereof, more preferably sawdust chips, planing chips, woodchips, wood particles or mixtures thereof.

The dimensions of comminuted lignocellulosics are not critical in that they are in line with the lignocellulose material to be produced.

Oriented strand board (OSB), for example, is produced using large chips known as strands. Mean particle size of strands used for OSB production is generally in the range from 20 to 300 mm, preferably in the range from 25 to 200 mm and more preferably in the range from 30 to 150 mm.

Chipboard is generally produced using small chips. The particles needed for this can be size classified by sieve analysis. Sieve analysis is described in DIN 4188 or DIN ISO 3310 for example. Mean particle size is generally in the range from 0.01 to 30 mm, preferably in the range from 0.05 to 25 mm and more preferably in the range from 0.1 to 20 mm.

Suitable fibers include wood fibers, cellulose fibers, hemp fibers, cotton fibers, bamboo fibers, miscanthus, bagasse or mixtures thereof, preferably wood fibers, hemp fibers, bamboo fibers, miscanthus, bagasse (sugarcane) or mixtures thereof, more preferably wood fibers, bamboo fibers or mixtures thereof. By means of Fiber length is generally in the range from 0.01 to 20 mm, preferably in the range from 0.05 to 15 mm and more preferably in the range from 0.1 to 10 mm.

The particles or fibers are generally—even when varietally pure, i.e., when only one of the aforementioned varieties (e.g., chips, woodchips or, respectively, wood fibers) are used—in the form of mixtures, the individual parts, particles or fibers of which differ in size and shape.

Processing to form the desired lignocellulosics may proceed in accordance with methods known per se (see for example: M. Dunky, P. Niemz, Holzwerkstoffe and Leime, pages 91 to 156, Springer Verlag Heidelberg, 2002).

Lignocellulosics are obtainable after they have been dried to the low water contents (in a customary narrow range, known as residual moisture content) customary after customary drying procedures known to a person skilled in the art; this water is not included in the weights specified and reported in the present invention.

Mean density of lignocellulosics according to the present invention is freely choosable, being merely dependent on the lignocellulosic used, and is generally in the range from 0.2 to 0.9 g/cm³, preferably in the range from 0.4 to 0.85 g/cm³, more preferably in the range from 0.4 to 0.75 g/cm³ and especially in the range from 0.4 to 0.6 g/cm³.

Lignocellulosics are known as high-density lignocellulosics when their mean density is in the range from 601 to 1200 kg/m³, preferably in the range from 601 to 850 kg/m³ and more preferably in the range from 601 to 800 kg/m³, and as low-density lignocellulosics when their mean density is in the range from 200 to 600 kg/m³, preferably in the range from 300 to 600 kg/m³ and more preferably in the range from 350 to 600 kg/m³. Fiberboard is known as high-density fiberboard (HDF) at a density ≧800 kg/m³, as medium-density fiberboard (MDF) at a density of between 650 and 800 kg/m³ and as lightweight fiberboard (LDF) at a density ≦650 kg/m³.

Component B

Component B) suitably is microfibrillated cellulose, also known as microcellulose, (cellulose) microfibrils, nanofibrillated cellulose, nanocellulose or (cellulose) nanofibrils (Cellulose 2010, 17, 459; page 460, right-hand column).

Microfibrillated cellulose is a cellulose which has been subjected to defibrillation. As a result, the individual microfibrils of the cellulosic fibers are partially or completely separated from each other. Microfibrillated cellulose has a mean fiber length of 0.1 to 1500 μm, preferably of 1 to 1500 μm, more preferably of 500 to 1300 μm and not less than 15 wt % of the fibers are less than 200 μm in length.

Microfibrillated celluloses generally have a BET surface area of 10 to 500 m²/g, preferably 20 to 100 m²/g, more preferably 30 to 75 m²/g.

Microfibrillated celluloses generally have a dewaterability of≧60 SR, preferably of ≧75 SR and more preferably of a ≧80 SR.

Mean fiber length is the weight-average fiber length (L_{W}) as determined to Tappi standard T271 (ref.: Tappi Journal, 45 (1962), No. 1, pages 38 to 45). The proportion of fibers not exceeding a certain length is likewise determined to Tappi standard T271.

The BET surface area of microfibrillated cellulose can be determined by the following procedure:

An aqueous formulation of the microfibrillated cellulose (suspension, gel) is placed on a frit and washed with tent-butanol. The resultant tert-butanol suspension of microfibrillated cellulose is transferred from the frit to a cooled metal plate (about 0° C.) with glass lid (lyophilizer, freeze dryer). The sample is dried in the with cooling overnight. tert-Butanol gradually sublimes to leave behind the structured microfibrillated cellulose in a freeze-dried state. The surface area of the spongelike, solid microfibrillated cellulose obtained is quantified by physisorption of nitrogen (measurement in a surface area BET measuring instrument (Micromeritics ASAP2420); the nitrogen loading is plotted against the nitrogen partial pressure and evaluated using BET theory).

SR values are determined by the Schopper-Riegler procedure of ISO 5267-1.

Cellulose is known per se and/or obtainable by methods known per se.

Microfibrillated cellulose is obtainable from commercially available cellulose or from celluloses for the paper industry.

Microfibrillated cellulose is obtainable in several ways:
a) extrusion of cellulose fibers in a twin-screw extruder as described in WO-A-2010/149711 or WO-A-2011/055148,
b) extrusion of cellulose fibers together with process and/or modifier chemicals as described in WO-A-2011/051882,
c) homogenizing a suspension of cellulose fibers by forcing this suspension under high pressure through a nozzle as described in EP-A-51230 or EP-A-402866, Example 1,
d) grinding cellulosic fibers, inter alia in a refiner as described in U.S. Pat. No. 6,379,594,
e) general mechanical comminution as described in EP-A-726356.

Microfibrillated cellulose is preferably produced by procedure a), b), d), e), more preferably by procedure a), b), d), in particular by procedure a), b).

Useful celluloses include recycled as well as virgin celluloses or mixtures thereof, in particular recycled as well as virgin cellulosic fibers or mixtures thereof. Any grades commonly used for this purpose can be used, examples being cellulose fibers obtained from mechanical pulps and from any fibers obtained from annual and perennial plants. Mechanical pulps include for example ground pulp, such as stone ground wood or pressure ground wood, thermomechanical pulp (TMP), chemithermomechanical pulp (CTMP), semichemical pulp, high-yield pulp and refiner mechanical pulp (RMP), and also wastepaper. Also suitable are chemical pulps, which can be used in bleached or unbleached form. Examples thereof are sulfate, sulfite and soda pulp. Among chemical pulps, preference is given to using bleached chemical pulps, which are also known as bleached kraft pulp. The stuffs and/or fibrous stocks referred to can be used alone or in admixture. The cellulose can be used as generated in the aforementioned manufacturing processes with or without secondary purification, preferably without secondary purification, and/or as used in papermaking.

Useful foundation stocks for cellulose, specifically mechanical pulp and chemical pulp, include cellulosic fibrous raw materials such as, for example, cellulose, raw fibers, entire plants comprising fibers, or plant constituents, such as stems, comprising fibers, and also annual and perennial plants, woods of any kind such as softwood or hardwood, i.e., woods of any desired wood species such as deciduous or coniferous woods, inter alia from residual industrial wood or plantation wood, for example eucalyptus, spruce, beech, pine, larch, lime, poplar, ash, chestnut and fir wood or mixtures thereof, preferably eucalyptus, spruce, beech, pine, larch, lime, poplar, ash, chestnut and fir wood or mixtures thereof, more preferably eucalyptus, spruce and beech wood or mixtures thereof, in particular eucalyptus and spruce wood or mixtures thereof, and also paper, board, card, wastepaper, wasteboard and wastecard.

Useful annual plants include hemp, flax, reed, cotton, wheat, barley, rye, oats, sugarcane (bagasse), maize stems, sunflower stems, sisal or kenaf. It is further possible to use fibrous agriwastes such as maize stems or sunflower stems as raw materials. To produce fiber from agriwastes, it is suitable to use cereal chaff such as oat or rice chaff and cereal straw, for example from wheat, yeast, rye or oats.

Useful perennial plants include woods of any kind, i.e., woods of any species of wood as described above.

The term “pulp” in this context is to be understood as meaning the porridgey mass (mash) obtainable by mechanical or chemical methods and having a solids content of 0 to 80 wt %, preferably 0.1 to 60 wt %, more preferably 0.5 to 50 wt %, which come from the comminution of the aforementioned raw materials.

Pulps can also be produced from refuse paper and wastepaper, alone or in admixture with other fibrous materials. The wastepaper used for this may come from a de-inking process or from an old corrugated container (OCC) pulp. It is also possible to use mixtures of post-use and virgin material.

Preferred cellulosic fibers comprise bleached chemical pulps, preferably bleached kraft pulps, preferably softwood kraft pulps and/or wastepaper.

The cellulosic fibers used as raw material can be pretreated before use. Such pretreatments can take the form of removing toxic or undesired chemistries, comminution, hammering, grinding, pinning or washing the material or alternatively combinations thereof.

According to the present invention, the cellulosic fibers used as starting material in the form of an aqueous mixture are subjected to mechanical shearing. The solids content of the fibrous mixture is generally in the range from 10 to 100 wt %, but normally in the range from 10 to 90 wt %, preferably in the range from 30 to 70 wt %, more preferably in the range from 40 to 60 wt %, in particular in the range from 50 to 60 wt %.

Component B) may comprise thermostable biocides. Preferred thermostable biocides are selected from the group of 2H-isothiazol-3-one derivatives, glutaraldehyde, pyrithione and its derivatives and benzalkonium chloride. Examples of 2H-isothiazol-3-one derivatives are methylisothiazolinone, chloromethylisothiazolinone, octylisothiazolinone and benzisothiazolinone. Examples of pyrithione derivatives are sodium pyrithione and dipyrithione. Particularly preferred thermostable biocides are selected from the group methylisothiazolinone, chloromethylisothiazolinone, octylisothiazolinone and benzisothiazolinone, glutaraldehyde, sodium pyrithione and benzalkonium chloride.

Component C

Suitable binders are resins such as phenol-formaldehyde resins, amino resins, organic isocyanates having at least 2 isocyanate groups, or mixtures thereof. The resins may be used as they are on their own, as a single resin constituent, or as a combination of two or more resin constituents of the different resins from the group consisting of phenol-formaldehyde resins, amino resins, and organic isocyanates having at least 2 isocyanate groups.

Phenol-formaldehyde Resins

Phenol-formaldehyde resins (also called PF resins) are known to the skilled person—see, for example, Kunststoff-Handbuch, 2nd edition, Hanser 1988, volume 10 “Duroplaste”, pages 12 to 40.

Amino Resins

As amino resins it is possible to use all amino resins that are known to the skilled person, preferably those known for the production of woodbase materials. Resins of this kind and also their preparation are described in for example, Ullmanns Enzyklopädie der technischen Chemie, 4th, revised and expanded edition, Verlag Chemie, 1973, pages 403 to 424 “Aminoplastae” and in Ullmann's Encyclopedia of Industrial Chemistry, Vol. A2, VCH Verlagsgesellschaft, 1985, pages 115 to 141 “Amino Resins”, and also in M. Dunky, P. Niemz, Holzwerkstoffe and Leime, Springer 2002, pages 251 to 259 (UF resins) and pages 303 to 313 (MUF and UF with a small amount of melamine), and may be prepared by reaction of compounds containing carbamide groups, preferably urea, melamine, or mixtures thereof, with the aldehydes, preferably formaldehyde, in the desired molar ratios of carbamide group to the aldehyde, preferably in water as solvent.

Setting the desired molar ratio of aldehyde, preferably formaldehyde, to the amino group which is optionally partly substituted by organic radicals, may also be done by addition of monomers bearing —NH₂ groups to completed, preferably commercial, relatively formaldehyde-rich amino resins. Monomers bearing NH₂ groups are preferably urea, melamine, or mixtures thereof, more preferably urea.

Amino resins are preferably considered to be polycondensation products of compounds having at least one carbamide group, optionally substituted to some extent by organic radicals (the carbamide group is also referred to as carboxamide group), and of an aldehyde, preferably formaldehyde; with particular preference, urea-formaldehyde resins (UF resins), melamine-formaldehyde resins (MF resins), or melamine-containing urea-formaldehyde resins (MUF resins), more particularly urea-formaldehyde resins, examples being Kaurit® glue products from BASF SE. Amino resins especially preferred in addition are polycondensation products made of compounds having at least one amino group, including amino groups partly substituted by organic radicals, and of aldehyde, in which the molar ratio of aldehyde to the amino group optionally partly substituted by organic radicals is in the range from 0.3:1 to 1:1, preferably 0.3:1 to 0.6:1, more preferably 0.3:1 to 0.45:1, very preferably 0.3:1 to 0.4:1.

The recited amino resins are typically used in liquid form, usually in suspension in a liquid medium, preferably in aqueous suspension, or else are used in solid form.

The solids content of the amino resin suspensions, preferably of the aqueous suspension, is typically 25 to 90 wt %, preferably 50 to 70 wt %.

The solids content of the amino resin in aqueous suspension may be determined according to Günter Zeppenfeld, Dirk Grunwald, Klebstoffe in der Holz-und Möbelindustrie, 2nd edition, DRW-Verlag, page 268. For determining the solids content of aminoplast glues, 1 g of aminoplast glue is weighed out accurately into a weighing pan, distributed finely on the base, and dried in a drying cabinet at 120° C. for 2 hours. After conditioning to room temperature in a desiccator, the residue is weighed and is calculated as a percentage fraction of the initial mass.

The weight figure for the binder, with regard to the aminoplast component in the binder, is based on the solids content of the corresponding component (determined by evaporating the water at 120° C. over the course of 2 hours, according to Gunter Zeppenfeld, Dirk Grunwald, Kiebstoffe in der Holz-und Möbelindustrie, 2nd edition, DRW-Verlag, page 268) and, in relation to the isocyanate, more particularly the PMDI, on the isocyanate component per se, in other words, for example, without solvent or emulsifying medium.

Organic Isocyanates

Suitable organic isocyanates are organic isocyanates having at least two isocyanate groups or mixtures thereof, more particularly all organic isocyanates or mixtures thereof that are known to the skilled person, preferably those known for the production of woodbase materials or polyurethanes. Organic isocyanates of these kinds and also their preparation and use are described in Becker/Braun, Kunststoff Handbuch, 3rd revised edition, volume 7 “Polyurethane”, Hanser 1993, pages 17 to 21, pages 76 to 88, and pages 665 to 671, for example.

Preferred organic isocyanates are oligomeric isocyanates having 2 to 10, preferably 2 to 8, monomer units and on average at least one isocyanate group per monomer unit, or mixtures thereof, more preferably the oligomeric organic isocyanate PMDI (“Polymeric Methylene Diphenylene Diisocyanate”), which is obtainable by condensation of formaldehyde with aniline and phosgenation of the isomers and oligomers formed in the condensation (see, for example, Becker/Braun, Kunststoff Handbuch, 3rd revised edition, volume 7 “Polyurethane”, Hanser 1993, page 18, last paragraph, to page 19, second paragraph, and page 76, fifth paragraph), very preferably products of the LUPRANAT® product series from BASF SE, more particularly LUPRANAT® M 20 FB from BASF SE.

Curing Agents in Component C

The binder C) may comprise curing agents or mixtures thereof that are known to the skilled person.

Suitable curing agents include all chemical compounds of any molecular weight that bring about or accelerate the polycondensation of amino resin or phenol-formaldehyde resin, and those which bring about or accelerate the reaction of organic isocyanate having at least two isocyanate groups with water or other compounds or substrates (wood, for example) which comprise —OH or —NH, —NH₂, or ═NH groups.

Suitable curing agents for amino resins of phenol-formaldehyde resins are those which catalyze the further condensation, such as acids or their salts, or aqueous solutions of these salts.

Suitable acids are inorganic acids such as HCl, HBr, Hl, H₂SO₃, H₂SO₄, phosphoric acid, polyphosphoric acid, nitric acid, sulfonic acids, as for example p-toluenesulfonic acid, methanesulfonic acid, trifluoromethanesulfonic acid, nonafluorobutanesulfonic acid, carboxylic acids such as C₁ to C₈ carboxylic acids as for example formic acid, acetic acid, propionic acid, or mixtures thereof, preferably inorganic acids such as HCl, H₂SO₃, H₂SO₄, phosphoric acid, polyphosphoric acid, nitric acid, sulfonic acids, such as p-toluenesulfonic acid, methanesulfonic acid, carboxylic acids such as C₁ to C₈ carboxylic acids as for example formic acid, acetic acid, more preferably inorganic acids such as H₂SO₄, phosphoric acid, nitric acid, sulfonic acids such as p-toluenesulfonic acid, methanesulfonic acid, and carboxylic acids such as formic acid and acetic acid.

Suitable salts are halides, sulfites, sulfates, hydrogensulfates, carbonates, hydrogencarbonates, nitrites, nitrates, sulfonates, salts of carboxylic acids such as formates, acetates, and propionates, preferably sulfites, carbonates, nitrates, sulfonates, salts of carboxylic acids such as formates, acetates, and propionates, more preferably sulfites, nitrates, sulfonates, salts of carboxylic acids such as formates, acetates, and propionates, of protonated, primary, secondary, and tertiary aliphatic amines, alkanolamines, cyclic aromatic amines such as C₁ to C₈ amines, isopropylamine, 2-ethylhexylamine, di(2-ethylhexyl)amine, diethylamine, dipropylamine, dibutylamine, diisopropylamine, tert-butylamine, triethylamine, tripropylamine, triisopropylamine, tributylamine, monoethanolamine, morpholine, piperidine, pyridine, and also ammonia, preferably protonated primary, secondary, and tertiary aliphatic amines, alkanolamines, cyclic amines, cyclic aromatic amines, and also ammonia, more preferably protonated alkanolamines, cyclic amines, and also ammonia, or mixtures thereof.

Salts that may be mentioned more particularly include the following: ammonium chloride, ammonium bromide, ammonium iodide, ammonium sulfate, ammonium sulfite, ammonium hydrogensulfate, ammonium methanesulfonate, ammonium-p-toluenesulfonate, ammonium trifluoromethanesulfonate, ammonium nonafluorobutanesulfonate, ammonium phosphate, ammonium nitrate, ammonium formate, ammonium acetate, morpholinium chloride, morpholinium bromide, morpholinium iodide, morpholinium sulfate, morpholinium sulfite, morpholinium hydrogensulfate, morpholinium methanesulfonate, morpholinium p-toluenesulfonate, morpholinium trifluoromethanesulfonate, morpholinium nonafluorobutanesulfonate, morpholinium phosphate, morpholinium nitrate, morpholinium formate, morpholinium acetate, monoethanolammonium chloride, monoethanolammonium bromide, monoethanolammonium iodide, monoethanolammonium sulfate, monoethanolammonium sulfite, monoethanolammonium hydrogensulfate, monoethanolammonium methanesulfonate, monoethanolammonium p-toluenesulfonate, monoethanolammonium trifluoromethanesulfonate, monoethanolammonium nonafluorobutanesulfonate, monoethanolammonium phosphate, monoethanolammonium nitrate, monoethanolammonium formate, monoethanolammonium acetate, or mixtures thereof,

The salts are used with very particular preference in the form of their aqueous solutions. Aqueous solutions are understood in this context to be dilute, saturated, supersaturated, and also partially precipitated solutions and also saturated solutions with a solids content of salt which is not further soluble.

Phenol-formaldehyde resins may also be cured alkalinically, preferably with carbonates or hydroxides such as potassium carbonate and sodium hydroxide.

Highly suitable curing agents of organic isocyanate having at least two isocyanate groups, as for example PMDI, may be divided into four groups; amines, other bases, metal salts, and organometallic compounds; amines are preferred. Curing agents of these kinds are described in, for example, Michael Szycher, Szycher's Handbook of Polyurethanes, CRC Press, 1999, pages 10-1 to 10-20.

Additionally suitable are compounds which greatly accelerate the reaction of compounds containing reactive hydrogen atoms, more particularly containing hydroxyl groups, with the organic isocyanates.

Usefully used as curing agents are basic polyurethane catalysts, examples being tertiary amines, such as triethylamine, tributylamine, dimethylbenzylamine, dicyclohexylmethylamine, dimethylcyclohexylamine, N,N,W,N′-tetramethyldiaminodiethyl ether, bis(dimethylaminopropyl)urea, N-methyl- and N-ethylmorpholine, N-cyclohexylmorpholine, N,N,N′,N′-tetramethylethylenediamine, N,N,N′,Nr-tetramethylbutanediamine, N,N,N′,N′-tetramethylhexane-1,6-diamine, pentamethyldiethylenetriamine, dimethylpiperazine, N-dimethylaminoethylpiperidine, 1,2-dimethylimidazole, 1-azabicyclo[2.2.0]octane, 1,4-diazabicyclo[2.2.2]octane (Dabco), and alkanolamine compounds, such as triethanolamine, triisopropanolamine, N-methyl- and N-ethyldiethanolamine, dimethylaminoethanol, 2-(N,N-dimethylaminoethoxy)ethanol, N,N′,N″-tris(dialkylaminoalkyl)hexahydrotriazines, e.g., N,N′,N″-tris(dimethylaminopropyl)-s-hexahydrotriazine, and triethylenediamine.

Suitable metal salts are iron(II) chloride, zinc chloride, lead octoate, preferably tin salts such as tin dioctoate.

Suitable organometallic compounds are tin dioctoate, tin diethylhexoate, and dibutyltin dilaurate, more particularly mixtures of tertiary amines and organic tin salts.

Suitability as further bases is possessed by amidines, such as 2,3-dimethyl-3,4,5,6-tetrahydropyrimidine, tetraalkylammonium hydroxides, such as tetramethylammonium hydroxide, alkali metal hydroxides, such as sodium hydroxide, and alkali metal alkoxides, such as sodium methoxide and potassium isopropoxide, and also by alkali metal salts of long-chain fatty acids having 10 to 20 C atoms and optionally pendant OH groups.

Further examples of curing agents for amino resins are found in M. Dunky, P. Niemz, Holzwerkstoffe und Leime, Springer 2002, pages 265 to 269, such curing agents for phenol-formaldehyde resins are found in M. Dunky, P. Niemz, Holzwerkstoffe und Leime, Springer 2002, pages 341 to 352, and such curing agents for organic isocyanates having at least 2 isocyanate groups are found in M. Dunky, P. Niemz, Holzwerkstoffe und Leime, Springer 2002, pages 385 to 391.

Component D

Component D) is composed of expanded plastics particles, which are optionally coated with a binder.

Expanded plastics particles, preferably expanded thermoplastics particles, are prepared from expandable plastics particles, preferably expandable thermoplastics particles. Both are based on or consist of polymers, preferably thermoplastic polymers, which can be foamed. These polymers are known to the skilled person.

Examples of highly suitable such polymers are polyketones, polysulfones, polyoxymethylenes, PVC (plasticized and unplasticized), polycarbonates, polyisocyanurates, polycarbodiimides, polyacrylimides and polymethacrylimides, polyamides, polyurethanes, amino resins and phenolic resins, styrene homopolymers (also referred to below as “polystyrene” or “styrene polymer”), styrene copolymers, C₂-C₁₀-olefin homopolymers, C₂-C₁₀-olefin copolymers, polyesters, or mixtures thereof, preferably PVC (plasticized and unplasticized), polyurethanes, styrene homopolymer, styrene copolymer, or mixtures thereof, more preferably styrene homopolymer, styrene copolymer, or mixtures thereof, more particularly styrene homopolymer, styrene copolymer, or mixtures thereof.

The above-described, preferred or more preferred expandable styrene polymers or expandable styrene copolymers have a relatively low blowing agent content. Polymers of this kind are also referred to as “low in blowing agent”. One highly suitable process for producing expandable polystyrene or expandable styrene copolymer that is low in blowing agent is described in U.S. Pat. No. 5,112,875, expressly incorporated herein by reference.

As described, it is also possible to use styrene copolymers. These styrene copolymers advantageously include at least 50 wt %, preferably at least 80 wt %, of copolymerized styrene. Examples of comonomers contemplated include α-methylstyrene, ring-halogenated styrenes, acrylonitrile, esters of acrylic or methacrylic acid with alcohols having 1 to 8 C atoms, N-vinylcarbazole, maleic acid (and/or maleic anhydride), (meth)acrylamides and/or vinyl acetate.

The polystyrene and/or styrene copolymer may advantageously comprise in copolymerized form a small amount of a chain branching agent, i.e., of a compound having more than one, preferably two double bonds, such as divinylbenzene, butadiene and/or butanediol diacrylate. The branching agent is used generally in amounts from 0.0005 to 0.5 mol %, based on styrene.

Mixtures of different styrene (co)polymers may also be used.

Highly suitable styrene homopolymers or styrene copolymers are crystal polystyrene (GPPS), high-impact polystyrene (HIPS), anionically polymerized polystyrene or high-impact polystyrene (A-IPS), styrene-α-methylstyrene copolymers, acrylonitrile-butadiene-styrene polymers (ABS), styrene-acrylonitrile (SAN), acrylonitrile-styrene-acrylate (ASA), methyl acrylate-butadiene-styrene (MBS), methyl methacrylate-acrylonitrile-butadiene-styrene (MABS) polymers, or mixtures thereof, or used with polyphenylene ether (PPE).

Preference is given to using styrene polymers, styrene copolymers, or styrene homopolymers having a molecular weight in the range from 70 000 to 400 000 g/mol, more preferably 190 000 to 400 000 g/mol, very preferably 210 000 to 400 000 g/mol.

Polystyrene and/or styrene copolymer of this kind may be produced by any of the polymerization processes known to the skilled person—see, for example, Ullmann's Encyclopedia, Sixth Edition, 2000 Electronic Release, or Kunststoff-Handbuch 1996, volume 4 “Polystyrol”, pages 567 to 598.

Where the expanded plastics particles consist of different types of polymer, i.e., of types of polymer based on different monomers, such as polystyrene and polyethylene, or polystyrene and homo-polypropylene, or polyethylene and homo-polypropylene, these different types of polymer may be present in different weight proportions—which, however, are not critical.

The expanded plastics particles are used in general in the form of beads or pellets with an average diameter of 0.25 to 10 mm, preferably 0.4 to 8.5 mm, more preferably 0.4 to 7 mm, more particularly in the range from 1.2 to 7 mm, and advantageously have a small surface area per unit volume, in the form, for example, of a spherical or elliptical particle.

The expanded plastics particles are advantageously closed-cell. The open-cell content according to DIN-ISO 4590 is generally less than 30%.

The expanded plastics particles have a bulk density of 10 to 150 kg/m³, preferably 30 to 100 kg/m³, more preferably 40 to 80 kg/m³, more particularly 50 to 70 kg/m³. The bulk density is typically ascertained by weighing a defined volume filled with the bulk material.

The expanded plastics particles generally still contain, if any, only a low level of blowing agent. The blowing agent content of the expanded plastics particle is generally in the range from 0 to 5.5 wt %, preferably 0 to 3 wt %, more preferably 0 to 2.5 wt %, very preferably 0 to 2 wt %, based in each case on the expanded polystyrene or expanded styrene copolymer. 0 wt % here means that no blowing agent can be detected using the customary detection methods.

These expanded plastics particles can be put to further use without or with—preferably without—further measures for reduction of blowing agent, and more preferably without further intervening steps, for producing the lignocellulosic.

The expandable polystyrene or expandable styrene copolymer, or the expanded polystyrene or expanded styrene copolymer, typically has an antistatic coating.

The expanded plastics particles may be obtained as follows:

Compact, expandable plastics particles, typically solids with in general no cell structure, and comprising an expansion-capable medium (also called “blowing agent”), are expanded (often also called “foamed”) by exposure to heat or a change in pressure. On such exposure, the blowing agent expands, the particles increase in size, and cell structures are formed.

This expansion is carried out in general in customary foaming devices, often referred to as “pre-expanders”. Pre-expanders of this kind may be fixed installations or else movable.

Expansion may be carried out in one or more stages. Generally speaking, with the one-stage process, the expandable plastics particles are expanded directly to the desired final size.

Generally speaking, in the case of the multistage process, the expandable plastics particles are first expanded to an intermediate size, and then expanded to the desired final size in one or more further stages, via a corresponding number of intermediate sizes.

The expansion is preferably carried out in one stage.

For the production of expanded polystyrene as component D) and/or of expanded styrene copolymer as component D), in general, the expandable styrene homopolymers or expandable styrene copolymers are expanded in a known way by heating to temperatures above their softening point, using hot air or, preferably, steam, for example, and/or using pressure change (this expansion often also being termed “foaming”), as described for example in Kunststoff Handbuch 1996, volume 4 “Polystyrol” Hanser 1996, pages 640 to 673, or in U.S. Pat. No. 5,112,875.

The expandable polystyrene or expandable styrene copolymer is generally obtainable in a conventional way by suspension polymerization or by means of extrusion techniques as described above. On expansion, the blowing agent expands, the polymer particles increase in size, and cell structures are formed.

The expandable polystyrene and/or styrene copolymer is prepared in general in a conventional way, by suspension polymerization or by means of extrusion techniques.

In the case of the suspension polymerization, styrene, optionally with addition of further comonomers, is polymerized using radical-forming catalysts in aqueous suspension in the presence of a conventional suspension stabilizer. The blowing agent and optionally further adjuvants may be included in the initial charge in the polymerization, or added to the batch in the course of the polymerization or when polymerization is at an end. The beadlike, expandable styrene polymers impregnated with blowing agent that are obtained, after the end of polymerization, are separated from the aqueous phase, washed, dried, and screened.

In the case of the extrusion process, the blowing agent is mixed into the polymer by an extruder, for example, and the material is conveyed through a die plate and pelletized under pressure to form particles or strands.

The resulting expanded plastics particles or coated expanded plastics particles can be stored temporarily and transported.

Suitable blowing agents are all blowing agents known to the skilled person, examples being aliphatic C₃ to C₁₀ hydrocarbons such as propane, n-butane, isobutane, n-pentane, isopentane, neopentane, cyclopentane and/or hexane and its isomers, alcohols, ketones, esters, ethers, halogenated hydrocarbons, or mixtures thereof, preferably n-pentane, isopentane, neopentane, cyclopentane, or a mixture thereof, more preferably commercial pentane isomer mixtures composed of n-pentane and isopentane.

The blowing agent content of the expandable plastics particle is generally in the range from 0.01 to 7 wt %, preferably 0.01 to 4 wt %, more preferably 0.1 to 4 wt %, very preferably 0.5 to 3.5 wt %, based in each case on the expandable polystyrene or styrene copolymer containing blowing agent.

Coating of Component D

Suitable coating materials for the expandable or expanded plastics particles include all compounds of components B and C and also compounds K, which form a tacky layer, or mixtures thereof, preferably all compounds of component C and also compounds K which form a tacky layer, more preferably all compounds of component C. Where the coating material has been selected from components C, it is possible for coating material and component C in the lignocellulose material to be the same or different, preferably the same.

Suitable compounds K which form a tacky layer are polymers based on monomers such as vinylaromatic monomers, such as α-methylstyrene, p-methylstyrene, ethylstyrene, tert-butylstyrene, vinylstyrene, vinyltoluene, 1,2-diphenylethylene, 1,1-diphenylethylene, alkenes, such as ethylene or propylene, dienes, such as 1,3-butadiene, 1,3-pentadiene, 1,3-hexadiene, 2,3-dimethylbutadiene, isoprene, or piperylene, α,β-unsaturated carboxylic acids, such as acrylic acid and methacrylic acid, esters thereof, more particularly alkyl esters, such as C₁ to C₁₀ alkyl esters of acrylic acid, more particularly the butyl esters, preferably n-butyl acrylate, and the C₁ to C₁₀ alkyl esters of methacrylic acid, more particularly methyl methacrylate (MMA), or carboxamides, such as acrylamide and methacrylamide, for example. These polymers may optionally comprise 1 to 5 wt % of comonomers, such as (meth)acrylonitrile, (meth)acrylamide, ureido(meth)acrylate, 2-hydroxyethyl (meth)acrylate, 3-hydroxypropyl (meth)acrylate, acrylamidopropanesulfonic acid, methylolacrylamide, or the sodium salt of vinylsulfonic acid. The constituent monomer or monomers of these polymers are preferably one or more of styrene, butadiene, acrylic acid, methacrylic acid, C₁ to C₄ alkyl acrylates, C₁ to C₄ alkyl methacrylates, acrylamide, methacrylamide, and methylolacrylamide. Additionally suitable in particular are acrylate resins, more preferably in the form of the aqueous polymer dispersion, and also homooligomers or homopolymers of α,β-unsaturated carboxylic acids or their anhydrides, and also cooligomers or copolymers of α,β-unsaturated carboxylic acids and/or their anhydrides with ethylenically unsaturated comonomers.

Suitable polymer dispersions are obtainable, for example, by radical emulsion polymerization of ethylenically unsaturated monomers, such as styrenes, acrylates, methacrylates, or a mixture thereof, as described in WO-A-00/50480, preferably pure acrylates or styrene-acrylates, synthesized from the monomers styrene, n-butyl acrylate, methyl methacrylate (MMA), methacrylic acid, acrylamide, or methylolacrylamide.

The polymer dispersion or suspension can be prepared in a conventional way, for instance by emulsion, suspension, or dispersion polymerization, preferably in aqueous phase. The polymer may also be prepared by solution or bulk polymerization, optionally comminution, and subsequent, conventional dispersing of the polymer particles in water.

The coating material can be contacted with the expandable plastics particles (“variant I”) or with the expanded plastics particles (“variant II”); preference is given to employing variant (II).

The coated plastics particles of the invention may be produced, for example, by
a) melting plastics particles, preferably nonexpandable plastics particles, adding one or more coating materials and blowing agent in any order, mixing them extremely homogeneously, and foaming the mixture to form foam particles;
b) coating expandable plastics particles with one or more coating materials and foaming them to form foam particles or
c) coating expandable plastics particles with one or more coating materials during or after pre-expanding.

Furthermore, the contacting may take place using the customary methods, as for example by spraying, dipping, wetting or drumming of the expandable or expanded plastics particles with the coating material at a temperature of 0 to 150° C., preferably 10 to 120° C., more preferably 15 to 110° C., under a pressure of 0.01 to 10 bar, preferably 0.1 to 5 bar, more preferably under standard pressure (atmospheric pressure); the coating material is preferably added in the pre-expander under the conditions specified above.

Component E)

The lignocellulose materials of the invention may comprise, as component E, additives known to the skilled person and commercially customary, in amounts of 0 to 68 wt %, preferably 0 to 10 wt %, more preferably 0.5 to 8 wt %, more particularly 1 to 3 wt %.

Examples of suitable additives include hydrophobicizing agents such as paraffin emulsions, antifungal agents, formaldehyde scavengers, such as urea or polyamines, and flame retardants, extenders, and fillers. Further examples of additives are found in M. Dunky, P. Niemz, Holzwerkstoffe und Leime, Springer 2002, pages 436 to 444.

Amounts of the components in the lignocellulose material

The microfibrillated cellulose has an overall dry mass in the range generally between 0.01 to 50 wt %, preferably between 0.05 and 40 wt %, more preferably between 0.1 and 30 wt %, based on the dry mass of the lignocellulosics.

The total amount of the binder C), based on the lignocellulosics, is generally in the range from 1 to 50 wt %, preferably 2 to 15 wt %, more preferably 3 to 10 wt %, with the amount
a) of the phenol-formaldehyde resin, based on the lignocellulosics, being generally in the range from 0 to 50 wt %, preferably 4 to 20 wt %, more preferably 5 to 15 wt %,
b) of the amino resin (calculated as solid, based on the lignocellulosics) being generally in the range from 0 to 45 wt %, preferably 4 to 20 wt %, more preferably 5 to 15 wt %, and
c) of the organic isocyanate, based on the lignocellulosics, being generally in the range from 0 to 7 wt %, preferably 0.1 to 5 wt %, more preferably 0.5 to 4 wt %.

The total amount of the coating material on the expanded plastics particles D) {based on the amount of the uncoated plastics particles} is in the range from 0 to 20 wt %, preferably 0 to 15 wt %, more preferably 0 to 10 wt %.

Even after pressing has taken place to form the lignocellulose material, preferably woodbase material, preferably multilayered lignocellulose material, more preferably multilayered woodbase material, the optionally coated, expanded plastics particles D) are generally present in a virtually unmelted state. This means that in general the plastics particles D) have not penetrated the lignocellulose particles or impregnated them, but they are instead distributed between the lignocellulose particles. The plastics particles D) can be separated from the lignocellulose typically by physical methods, after the comminution of the lignocellulose material, for example.

The total amount of the coated, expanded plastics particles D), based on the lignocellulose-containing, preferably wood-containing substance, is in the range from 0 to 25 wt %, preferably 0 to 20 wt %, more preferably 0 to 15 wt %.

Multilayered Method

The present invention further relates to a method for producing a single- or multilayered lignocellulose material comprising at least three layers, wherein either only the middle layer or at least some of the middle layers comprise a lignocellulosic as defined above, or wherein at least one further layer, as well as the middle layer or at least some of the middle layers, comprises a lignocellulosic as defined above, the components for the individual layers being layered atop another and compressed at elevated temperature and elevated pressure.

The average density of the multilayered lignocellulose material, preferably woodbase material, of the invention, preferably of the three-layer lignocellulose material, preferably woodbase material, of the invention, is generally not critical.

Relatively high-density multilayered, preferably three-layer, lignocellulose materials, preferably woodbase materials, of the invention typically have an average density in the range from at least 600 to 900 kg/m³, preferably 600 to 850 kg/m³, more preferably 600 to 800 kg/m³.

Low-density multilayered, preferably three-layer, lignocellulose materials, preferably woodbase materials, of the invention typically have an average density in the range from 200 to 600 kg/m³, preferably 300 to 600 kg/m³, more preferably 350 to 500 kg/m³.

Preferred parameter ranges and also preferred embodiments for the average density of the lignocellulose-containing, preferably wood-containing substance and for the components and also their preparation processes, A), B), C), D) and E), and also the combination of the features, correspond to those described above.

Middle layers in the sense of the invention are all layers which are not the outer layers.

Microfibrillated cellulose in the present invention can be applied in various ways:
a) spraying a liquid MFC formulation (solution, dispersion, suspension) onto the wood chips/fibers, or
b) mixing the solid, preferably pulverulent, MFC with the wood chips/fibers, or
c) forming a liquid or solid MFC-binder mixture and applying it to or mixing it with the wood chips/fibers, or
d) adding MFC before or during the production of wood chips/fibers in the flaker or refiner.

Procedure a)

A liquid MFC formulation can be sprayed onto wood chips/fibers before or after application of binder C). The solvent used is water, preferably tap water, deionized water, demineralized water or distilled water. The concentration of MFC in the aqueous formulation is chosen such that the latter is still readily sprayable onto the wood chips and the MFC becomes uniformly dispersed across the chips. The solids content of the MFC formulation is between 0.01 and 20%, preferably between 0.05 and 15%, more preferably between 0.1 and 10%.

Procedure b)

Adding solid MFC to the wood chips/fibers can take place before or after application of binder C). The MFCs used should be pulverulent and free flowing. The amount of MFC based on the amount of wood chips/fibers is between 0.01 and 50 wt %, preferably between 0.1 and 30 wt %, more preferably between 0.1 and 15 wt %.

Procedure c)

The MFC is formulated in binder C) such that
i) a still liquid MFC-binder formulation is formed
ii) said binder C) is completely absorbed by the MFC to form a solid formulation.

Care must be taken with the preparation of the still liquid MFC formulation i) to ensure that the concentration of MFC in the formulation is chosen such that the latter is still readily sprayable onto the wood chips/fibers. The amount of MFC based on the solids content of the binder is preferably between 0.001 and 20 wt %, more preferably between 0.01 and 10 wt %, more preferably between 0.1 and 5 wt %. Solid formulation ii) is formed by admixing the MFC with just sufficient binder C) that the resultant solid is still just pulverulent and free flowing.

Procedure d)

The MFC is preferably added in granular form at the production stage of the wood chips/fibers. The MFC is preferably added to the hogged wood in or upstream of the flaker for the production of wood chips or in or upstream of the refiner for the production of wood fibers. The amount of MFC based on the amount of wood chips/fibers is between 0.01 and 50 wt %, preferably between 0.1 and 30 wt %, more preferably between 0.5 and 15 wt %,

The multilayered lignocellulose material, preferably multilayered woodbase material, of the invention preferably comprises three lignocellulose layers, preferably wood material layers, the outer layers in total generally being thinner than the inner layer or layers.

The binder used for the outer layers is typically an amino resin, as for example urea-formaldehyde resin (UF), melamine-formaldehyde resin (MF), melamine-urea-formaldehyde resin (MUF), or the binder C) of the invention. The binder used for the outer layers is preferably an amino resin, more preferably a urea-formaldehyde resin, very preferably an amino resin in which the molar formaldehyde-to—NH₂-groups ratio is in the range from 0.3:1 to 3:1.

In a preferred embodiment, the outer layers do not contain expanded plastics particles D).

The thickness of the multilayered lignocellulose material, preferably multilayered woodbase material, of the invention varies with the field of use and is situated generally in the range from 0.5 to 100 mm, preferably in the range from 10 to 40 mm, more particularly 12 to 40 mm.

The methods for producing multilayered woodbase materials are known in principle and described for example in M. Dunky, P. Niemz, Holzwerkstoffe und Leime, Springer 2002, pages 91 to 150.

One example of a method for producing a multilayered woodbase material of the invention is described hereinafter.

If used, component D is foamed up from expandable plastics particles and optionally coated with coating material.

After the wood has been chipped, the chips are dried. Then any coarse and fine fractions are removed. The remaining chips are sorted by screening or classifying in a stream of air. The coarser material is used for the middle layer, the finer material for the outer layers.

The outer-layer chips are resinated, or mixed, separately from the middle-layer chips, with component B) as 2.5 wt % aqueous suspension, component C), with curing agents—these curing agents are preferably admixed shortly before the use of the component C—and optionally with component E. This mixture is referred to below as outer-layer material.

The middle-layer chips are resinated, or mixed, separately from the outer-layer chips with component B) as 2.5 wt % aqueous suspension, optionally with the optionally coated component D), component C), with curing agents—these curing agents are preferably admixed shortly before the use of the component C)—and optionally with component E). This mixture is referred to below as middle-layer material.

The chips are subsequently scattered,

First the outer-layer material is scattered onto the shaping belt, then the middle-layer material—comprising the coated components B), C), and optionally D) and E)—and finally outer-layer material one more time. The outer-layer material is divided such that both outer layers comprise approximately equal amounts of material. The three-layer chip cake produced in this way is subjected to cold (generally room-temperature) precompaction and then to hot pressing.

Pressing may take place by any methods known to the skilled person. The cake of wood particles is typically pressed to the desired thickness at a pressing temperature of 150 to 230° C. The pressing time is normally 3 to 15 seconds per mm of panel thickness. A three-layer chipboard panel is obtained.

The mechanical strength may be determined by measurement of the transverse tensile strength in accordance with EN 319.

The addition of microfibrillated cellulose to the wood chips/fibers improves the transverse tensile strength and makes possible the production of lignocellulose materials using a reduced amount of binder overall. It is further possible to produce lightweight lignocellulose materials.

Lignocellulose materials, more particularly multilayered woodbase materials, are an inexpensive alternative to solid wood, representing a sparing use of resources; they have great significance, and are used in the manufacture of articles of any kind and in the building construction sector, more particularly in the manufacture of furniture and furniture components (in furniture construction), of packaging materials, of laminate flooring, and as building construction materials, in house building or in interior fitment, or in motor vehicles.

Microfibrillated cellulose is suitable for producing shaped lignocellulosic articles (use),

### EXAMPLES

### Preparation of the Component B)

The microfibrillated cellulose used was produced by the process described WO-A-2010/149711.

Preparing a Dispersion of Component B)

3800 g of water and 200 g of microfibrillated cellulose (50% solids content) were stirred using an Ultra Turrax T50 from Janke&Kunkel until a homogeneous suspension was obtained. Shortly before using the suspension, the homogeneity of the suspension was checked once more and restored by renewed stirring.

Production of Panels

The glue used was urea-formaldehyde glue (Kaurit® Leim 347 from BASF SE). The solids content was adjusted to 67 wt % with water in each case.

Production of Outer-Layer Material

In a mixer, 500 g of chips were admixed with 40 g of the previously prepared MFC suspension for 60 s. Then 102 g of a glue liquor composed of 100 parts of Kaurit®-Leim 347 glue and 1 part of a 52% strength aqueous ammonium nitrate solution, 0.5 part of urea, 0.7 part of a 44% strength aqueous paraffin dispersion and 40 parts of water were applied.

Production of Middle-Layer Material

In a mixer, 500 g of chips (component A) were admixed with 40 g of the previously prepared MFC suspension for 60 s. Then 95 g of a glue liquor composed of 100 parts of Kaurie-Leim 347 glue and 4 parts of a 52% strength aqueous ammonium nitrate solution, 1.3 parts of urea and 1.1 parts of a 44% strength aqueous paraffin dispersion were applied.

Compressing of Resinated Chips

The microfibrillated-cellulose-treated and resinated chips were filled into a 30×30 cm mold as follows:

First of all, half of the outer-layer material was scattered into the mold. Then 50 to 100% of the middle-layer material was applied as a layer over it. Lastly, the second half of outer-layer material was applied as a layer over this, and the whole was subjected to cold precompaction. This was followed by pressing in a hot press (pressing temperature 210° C., pressing time 120 s). The specification thickness of the panel was 16 mm in each case.

Investigation of the Lightweight, Wood-Containing Substance

Density:

The density was determined 24 hours after production. For this purpose, the ratio of mass to volume of a Was specimen was determined at the same moisture content. The square test specimens had a side length of 50 mm, with an accuracy of 0.1 mm. The thickness of the test specimen was measured in its center, to an accuracy of 0.05 mm. The accuracy of the balance used for determining the mass of the test specimen was 0.01 g. The gross density ρ (kg/m³) of a test specimen was calculated by the following formula:

ρ=m/(b₁*b₂*d)*10⁶

Here:
m is the mass of the test specimen, in grams, and
b₁, b₂, and d are the width and thickness of the test specimen, in millimeters.

A precise description of the procedure can be found in DIN EN 323, for example.

Transverse Tensile Strength:

The transverse tensile strength is determined perpendicular to the board plane. For this purpose, the test specimen was loaded to fracture with a uniformly distributed tensile force. The square test specimens had a side length of 50 mm, with an accuracy of 1 mm, and angles of exactly 90°. Moreover, the edges were clean and straight. The test specimens were bonded to the yokes by means of a suitable adhesive, an epoxy resin, for example, and dried for at least 24 hours in a controlled-climate cabinet at 20° C. and 65% atmospheric humidity. The test specimen prepared in this way was then clamped into the testing machine in a self-aligning manner with a shaft joint on both sides, and then loaded to fracture at a constant rate, with the force needed to achieve this being recorded. The transverse tensile strength ft (N/mm²) was calculated by the following formula:

fₗ=Fₘₐₓ/(a*b)

Here:
Fₘₐₓ is the breaking force in newtons
a and b are the length and width of the test specimen, in millimeters.

A precise description of the procedure can be found in DIN EN 319, for example.

Flexural Strength

The flexural strength was determined by applying a load in the middle of a test specimen lying on two points. The test specimen had a width of 50 mm and a length of 20 times the nominal thickness plus 50 mm, but not more than 1050 mm and not less than 150 mm. The test specimen was then placed flatly onto two bearing mounts, the inter-center distance of which was 20 times the thickness of the test specimen, and the test specimen was then loaded to fracture in the middle with a force, this force being recorded. The flexural strength fₘ(N/mm²) was calculated by the following formula:

fₘ=(3*Fₘₐₓ*I)/2*b*t²)

Here:
Fₘₐₓ is the breaking force in newtons
I is the inter-center distance of the bearing mounts, in millimeters
b is the width of the test specimen, in millimeters
t is the thickness of the test specimen, in millimeters.

A precise description of the procedure can be found in DIN EN 310.

Screw Pullout Resistance

The screw pullout resistance was determined by measuring the force needed to pull out a screw in an axially parallel fashion from the test specimen. The square test specimens had a side length of 75 mm, with an accuracy of 1 mm. First of all, guide holes with a diameter of 2.7 mm (±0.1 mm), and depth of 19 mm (±1 mm) were drilled perpendicular to the surface of the test specimen into the central point of the surface. Subsequently, for the test, a steel screw with nominal dimensions of 4.2 mm×38 mm, having a ST 4.2 thread in accordance with ISO 1478 and a pitch of 1.4 mm, was inserted into the test specimen, with 15 mm (±0.5 mm) of the whole screw being inserted. The test specimen was fixed in a metal frame and, via a stirrup, a force was applied to the underside of the screw head, the maximum force with which the screw was pulled out being recorded.

The results of the tests are summarized in the table.

The quantity figures are based in each case on the dry substance. When parts by weight are stated, the dry wood or the sum of the dry wood and the filler was taken as 100 parts. When % by weight is stated, the sum of all the dry constituents of the lightweight, wood-containing material is 100%.

The tests in the table without addition of component reinforcements serve as a comparison and were carried out without microfibrillated cellulose.

[1]=comparative test without microfibrillated cellulose

[2]=comparative tests from Holz als Roh-und Werkstoff 1970, 28, 3, pages 101 to 104 where test 10 corresponds to Example E and test 11 to Example K.

| | | Amount ratios: |
|---|---|---|
| | Target density | middle layer/outer layer |
| Test | [kg/m³] | (total) [g] |
| 1^{[1]} | 550 | 569/281 (850) |
| 2^{[1]} | 600 | 644/316 (960) |
| 3^{[1]} | 650 | 696/344 (1040) |
| 4 | 550 | 569/281 (850) |
| 5 | 600 | 644/316 (960) |
| 6 | 650 | 696/344 (1040) |
| 7 | 550 | 569/281 (850) |
| 8 | 600 | 644/316 (960) |
| 9 | 650 | 696/344 (1040) |

| | |
|---|---|
| 10 | see^{[2]} |
| 11 | |

| | | Transverse | | |
|---|---|---|---|---|
| | Density | tensile strength | Flexural strength | Screw pullout |
| Test | [kg/m³] | [N/mm²] | [N/mm²] | resistance [N] |
| 1^{[1]} | 532 | 0.49 | 13.41 | 465 |
| 2^{[1]} | 619 | 0.61 | 22.80 | 645 |
| 3^{[1]} | 667 | 0.71 | 24.01 | 745 |
| 4 | 553 | 0.64 | 15.79 | 549 |
| 5 | 609 | 0.73 | 21.05 | 720 |
| 6 | 657 | 0.92 | 24.79 | 773 |
| 7 | 551 | 0.60 | 15.17 | 592 |
| 8 | 606 | 0.69 | 19.35 | 669 |
| 9 | 642 | 0.82 | 22.72 | 670 |
| 10^{[2]} | 579 | 0.35 3.5 kp/cm²) | 25.8 (258.1 kp/cm²) | — |
| 11^{[2]} | 669 | 0.35 (3.5 kp/cm²) | 15.0 (149.9 kp/cm²) | — |

^{[1]}= comparative test without microfibrillated cellulose
^{[2]}= comparative tests from Holz als Roh-und Werkstoff 1970, 28, 3, pages 101 to 104 where test 10 corresponds to Example E and test 11 to Example K.

1. A lignocellulose material, comprising
A) 30 to 98.99 wt % of one or more lignocellulosics,
B) 0.01 to 50 wt % of microfibrillated cellulose,
C) 1 to 50 wt % of a binder selected from the group consisting of amino resin, phenol formaldehyde resin, organic isocyanate having two or more isocyanate groups. and mixtures thereof, optionally with a curing agent, and
D) 0 to 25 wt % of expanded plastics particles having a bulk density in the range from 10 to 150 kg/m³, and
E) 0 to 68 wt % of additives.

2. The lignocellulose material according to claim 1 wherein the microfibrillated cellulose has an overall dry mass in the range of 0.05 and 40 wt %, based on the dry mass of the lignocellulosics.

3. The lignocellulose material according to claim 1 wherein the microfibrillated cellulose has a mean fiber length in a range from 0.1 to 1500 μm.

4. The lignocellulose material according to claim 1 wherein at least 15 wt % of the fibers of the microfibrillated cellulose are less greater than 200 μm in length.

5. The lignocellulose material according to claim 1 wherein the microfibrillated cellulose has a BET surface area in the a range from 10 to 500 m²/g.

6. The lignocellulose material according to claim 1 wherein the microfibrillated cellulose has a dewaterability of ≧60 SR.

7. The lignocellulose material according to claim 1 wherein the lignocellulosics includes from 20 to 100 wt % of lignocellulose.

8. The lignocellulose material according to claim 4 wherein the lignocellulosics includes from 20 to 100 wt % of lignocellulose.

9. The lignocellulose material according to claim 1 wherein the lignocellulosics comprise straw, woody plants, wood or mixtures thereof.

10. A method of producing a lignocellulose material according to claim 1, which method comprises mixing
A) 30 to 98.99 wt % of one or more lignocellulosics,
B) 0.01 to 50 wt % of microfibrillated cellulose,
C) 1 to 50 wt % of a binder selected from the group consisting of amino resin, phenol-formaldehyde resin, organic isocyanate having two or more isocyanate groups, or mixtures thereof, optionally with a curing agent,
D) 0 to 25 wt % of expanded plastics particles having a bulk density in the range from 10 to 150 kg/ m³, and
E) 0 to 68 wt % of additives, to form a mixture, and
compressing the mixture at elevated temperature and at elevated pressure.

11. A method of producing a multilayered lignocellulose material comprising at least three layers, wherein one or more middle layers comprise a lignocellulosic as defined in claim 1, or at least one further layer, as well as the one or more middle layers, comprises a lightweight lignocellulosic as defined in claim 1, the method comprises layering individual layers atop each other to form a multilayer, and compressing the multilayer at elevated temperature and elevated pressure.

12. The method according to claim 11 wherein outer layers of the multilayered lignocellulose material do not include expanded plastics particles B).

13. A lignocellulose material obtained by a method according to claim 11.

14. A multilayered lignocellulose material obtained by a method according to claim 12.

15. A building construction material comprising the multilayered lignocellulose material according to claim 11.

16. The building construction material according to claim 15 selected from furniture and furniture components, or laminate flooring.

17. A lignocellulose material comprising:
30 to 98.99 wt % of one or more lignocellulosics;
0.01 to 50 wt % of microfibrillated cellulose with a mean fiber length in a range from 500 to 1300 μm, and at least 15 wt % of the fibers of the microfibrillated cellulose are greater than 200 μm in length;
1 to 50 wt % of a binder selected from the group consisting of amino resin, phenol-formaldehyde resin, organic isocyanate having two or more isocyanate groups, and mixtures thereof, and optionally a curing agent.

18. The lignocellulose material, according to claim 17 wherein the microfibrillated cellulose has a BET surface area in a range from 10 to 500 m²/g, and a dewaterability of ≧60 SR.
